(19) United States
(12) Patent Application Publication
(10) Pub. No.: US 2014/0184566 A1
(43) Pub. Date: Jul. 3, 2014

(54) ELECTRONIC APPARATUS, METHOD OF CONTROLLING THE SAME, AND COMPUTER-READABLE RECORDING MEDIUM

(71) Applicants: Samsung Electronics Co., Ltd, Suwon-si (KR); Stimulant, San Francisco, CA (US); Huge Design, San Francisco, CA (US)

(72) Inventors: Allan VELZY, San Jose, CA (US); John Wayne HILL, San Francisco, CA (US); Ritesh LALA, San Francisco, CA (US); Chris HARSACKY, San Francisco, CA (US); Rob SWINTON, San Francisco, CA (US); Lee GRANAS, San Francisco, CA (US)

(73) Assignees: Samsung Electronics Co., Ltd, Suwon-si (KR); Stimulant, San Francisco, CA (US); Huge Design, San Francisco, CA (US)

(21) Appl. No.: 14/141,783

(22) Filed: Dec. 27, 2013

Related U.S. Application Data
(60) Provisional application No. 61/747,011, filed on Dec. 28, 2012.

(30) Foreign Application Priority Data
Aug. 21, 2013 (KR) 10-2013-0098945

(51) Int. Cl. G06F 3/041; G06F 3/044

(52) U.S. Cl. CPC G06F 3/0416; G06F 3/044
USPC 345/174; 345/173

(57) ABSTRACT

An electronic apparatus includes a display configured to display an image, a touch sensor configured to sense more than three touch areas on a surface of the display, a distinguisher configured to distinguish a touch pattern with respect to the sensed touch areas based on a number of the sensed touch areas and a total distance between the sensed touch areas, and a controller configured to perform an event that corresponds to the distinguished touch pattern.

### CROSS-REFERENCE TO RELATED APPLICATIONS

This application claims the benefit of priority under 35 U.S.C. §119 to U.S. Provisional Patent Application No. 61/747,011, filed on Dec. 28, 2012, in the U.S. Patent and Trademark Office, and Korean Patent Application No. 10-2013-0098945, filed on Aug. 21, 2013, in the Korean Intellectual Property Office, the content of each of which is incorporated herein in its entirety by reference.

### BACKGROUND OF THE INVENTION

1. Field of the Invention

Devices, methods, and media embodiments of the inventive concept relate to an electronic apparatus, a method of controlling the same, and a computer-readable recording medium, and more specifically, to an electronic apparatus configured to recognize touch patterns based upon a total distance between a plurality of touch points, a controlling method thereof, and a computer-readable recording medium.

2. Description of the Related Art

Personal computers and tablet computers are often used to drive application programs of game software that use at least one of related input devices such as, for example, a mouse, a keyboard, a joystick, or a handle-type control device. With the emergence of touch screen displays or, to be more specific, multi-touch functions, software game application programs have begun to use touch gestures as a method to provide a user input.

Specifically, in the related arts, touch gestures by users are sensed using, for example, a transparent overlay sensing method, an opaque embedded sensing method, and a camera-based sensing method. The transparent overlay sensing method recognizes finger touches using a capacitive wired antenna provided within an overlay, which has been used in various electronic applications. Recently, a capacitive wired antenna mounted within a smart phone and has been developed and widely used.

The opaque embedded sensing method, which was developed by Mitsubishi Electronics Research Laboratory in 2001, connects a large-table projection display to a capacitive joining antenna grid that can recognize electrical current leakage when a finger touches a display within specific coordinates designated for natural analog human interaction. For example, this method is used to connect transmitting arrays within the display to chairs upon which users sit and senses this interaction according to the capacitive method.

The camera-based sensing method uses computer image algorithms that compare a hand with its background in order to sense to which object a user points. One of the disadvantages of this method is that an object to be sensed should be placed within the scope of a lens of a camera. Thus, performance of this sensing system can be limited due to occlusion caused by the other objects that are not intended to be sensed in many cases.

Meanwhile, Microsoft Research has recently developed ThinSight (or PixelSense). An infrared (IR) optical layer of such technology is used to sense interaction of human fingers with an IR-reflective surface. By using this technology, infrared lights are used near the surface or are projected from the back face of the display surface to break the flatness of the infrared layer in order to sense an object.

By developing such IR optical multi-touch technologies, objects such as human fingers can be sensed. An IR dot reflecting system has recently developed. This system can recognize a direction of an object on a table that corresponds to the object through use of a unique method.

Therefore, current multi-touch technology has reached a point in human touch interaction. However, electronic methods that can perform multi-touch interaction through non-electronic objects have not been discussed as an avenue of development. For example, a method of multi-touch capacitive die from a pair of dice has not yet been developed. Further, although the related methods briefly mention methods of using multi-touch objects, they are not sufficient to recognize complicated or detailed objects.

### SUMMARY OF THE INVENTION

Exemplary embodiments of the present inventive concept overcome the above disadvantages and other disadvantages not described above. However, the present inventive concept is not required to overcome the disadvantages described above, and a particular embodiment of the present inventive concept may not overcome any of the problems described above.

The present inventive concept provides an electronic apparatus that can recognize touch patterns by using a total distance between a plurality of touch points, a controlling method thereof, and a computer-readable recording medium.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing an electronic apparatus that may include a display configured to display an image, a touch sensor configured to sense more than three touch areas on a surface of the display, a distinguisher configured to distinguish a touch pattern with respect to the sensed touch areas based on a number of the sensed touch areas and a total distance between the sensed touch areas, and a controller configured to perform an event that corresponds to the distinguished touch pattern.

The distinguisher may be configured to determine whether distances between the sensed touch areas are within a predetermined interval range, and to distinguish the touch pattern by comparing the total distance between the sensed touch areas with prestored information.

The distinguisher may be configured to distinguish the touch pattern by using an average of the total distance between the sensed touch areas for a predetermined time with respect to the touch areas sensed during the predetermined time.

The controller may be configured to perform the event that corresponds to the distinguished touch pattern and a position of the distinguished touch pattern on the display.

The controller may be configured to control the display to display an image that corresponds to the distinguished touch pattern.

A touch area of the more than three touch areas may be configured to be generated at a location of an object in which the touch pattern, in a form of a plurality of capacitive touch points, is arranged on a first side of the object.

In this case, the object may include capacitive lines arranged on the first side and on a second side different from the first side in order to deliver a capacitive amount caused by a touch of a user to the plurality of capacitive touch points.

A first of the plurality of capacitive touch points may have a predetermined distance from a second of the plurality of capacitive touch points.

In this case, the distinguisher may be configured to sense a direction of the touch pattern by using directions and distances between the first of the plurality of capacitive touch points that has the predetermined distance from the second of the plurality of capacitive touch points and other of the plurality of touch points.

In this case, the controller may be configured to perform the event that corresponds to the distinguished touch pattern and the sensed direction of the touch pattern.

The foregoing and/or other features and utilities of the present inventive concept also provide a method of controlling an electronic apparatus that includes displaying an image, sensing more than three touch areas on a surface of a display, distinguishing a touch pattern with respect to the sensed touch areas based on a number of the sensed touch areas and a total distance between the sensed touch areas, and performing an event that corresponds to the distinguished touch pattern.

The distinguishing may include determining whether distances between the sensed touch areas are within a predetermined interval range, and distinguishing the touch pattern by comparing the number of the sensed touch areas, the total distance between the sensed touch areas, and prestored information.

The distinguishing may include distinguishing the touch pattern by using an average of the total distance between the sensed touch areas for a predetermined time with respect to the touch areas sensed during the predetermined time.

The performing may include performing the event that corresponds to the distinguished touch pattern and a position of the distinguished touch pattern on the display.

The performing may further include displaying an image that corresponds to the distinguished touch pattern.

A touch area of the more than three touch areas may be generated at a location of an object in which the touch pattern, in a form of a plurality of capacitive touch points, is arranged on a side of the object.

A first of the plurality of capacitive touch points may have a predetermined distance from a second of the plurality of capacitive touch points.

In this case, the distinguishing may further include sensing a direction of the touch pattern by using directions and distances between the first of the plurality of capacitive touch points that have the predetermined distance from the second of the plurality of capacitive touch points and other of the plurality of capacitive touch points.

In this case, the performing may include performing the event that corresponds to the distinguished touch pattern and the sensed direction of the touch pattern.

The foregoing and/or other features and utilities of the present inventive concept also provide a non-transitory computer-readable recording medium that includes a program to implement a method of controlling an electronic apparatus, the method may include displaying an image, sensing more than three touch areas on a surface of a display, distinguishing a touch pattern with respect to the sensed touch areas based on a number of the sensed touch areas and a total distance between the sensed touch areas, and performing an event that corresponds to the distinguished touch pattern.

The foregoing and/or other features and utilities of the present inventive concept also provide an electronic apparatus that includes a user interface having a touch screen and configured to identify locations of touch points, a processing element configured to compute, in response to the locations, a determination of a pattern from at least one of a number of the touch points and a total distance between the touch points, and a controller configured to execute, in response to the determination, an application that corresponds to the pattern.

The processing element may be an electronic processor.

Alternatively, the processing element may be an instruction on a non-transitory computer-readable recording medium configured to be executed by the controller.

The foregoing and/or other features and utilities of the present inventive concept also provide a controller that includes an input configured to receive a signal indicative of locations of touch points on a display, and an electronic processing element configured to compute, in response to the signal, a determination of a pattern from at least one of a number of the touch points and a total distance between the touch points, and to execute, in response to the determination, an application that corresponds to the pattern.

The foregoing and/or other features and utilities of the present inventive concept also provide a method of controlling an electronic apparatus that includes receiving, at an electronic processing element, a signal indicative of locations of touch points on a display, computing, at the electronic processing element, in response to the signal, a determination of a pattern from at least one of a number of the touch points and a total distance between the touch points, and executing, at the electronic processor, in response to the determination, an application that corresponds to the pattern.

The foregoing and/or other features and utilities of the present inventive concept also provide a non-transitory computer-readable recording medium containing instructions which, when executed by an electronic processing element, cause the electronic processing element to perform a method of controlling an electronic apparatus that includes receiving, at an electronic processing element, a signal indicative of locations of touch points on a display, computing, at the electronic processing element, in response to the signal, a determination of a pattern from at least one of a number of the touch points and a total distance between the touch points, and executing, at the electronic processor, in response to the determination, an application that corresponds to the pattern.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 illustrates an electronic system according to an embodiment of the present inventive concept;

FIG. 2 is a block diagram of an example of the electronic apparatus illustrated in FIG. 1;

FIG. 3 illustrates an example of a pattern object in which touch patterns, described with reference to FIG. 2, are arranged on sides of the pattern object;

FIG. 4 illustrates an example in which the pattern object illustrated in FIG. 3 is presented in one dimension;

FIG. 5 illustrates an example of a pattern object in which touch patterns are arranged on sides according to another embodiment of the present inventive concept;

FIGS. 6 and 7 are views to explain operation of the electronic system according to an embodiment of the present inventive concept;

FIG. 8 illustrates an example of touch patterns according to an embodiment of the present inventive concept;

FIG. 9 illustrates an example of a pattern object that uses the touch patterns illustrated in FIG. 8;

FIG. 10 illustrates an example of touch patterns according to an embodiment of the present inventive concept;

FIG. 11 illustrates an example of a pattern object that uses the touch patterns illustrated in FIG. 10;

FIG. 12 is a flowchart illustrating a method of controlling operation of the electronic apparatus according to an embodiment of the present inventive concept; and

FIGS. 13 to 15 are flowcharts illustrating operations to recognize touch patterns as initially described with reference to FIG. 12.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

The matters defined in the description, such as detailed construction and elements, are provided to assist in a comprehensive understanding of the present inventive concept. Accordingly, it is apparent that the exemplary embodiments of the present inventive concept can be carried out without those specifically defined matters. Also, well-known functions or constructions are not described in detail since they would obscure the present inventive concept with unnecessary detail.

Referring to the attached drawings, the present inventive concept is described in detail below.

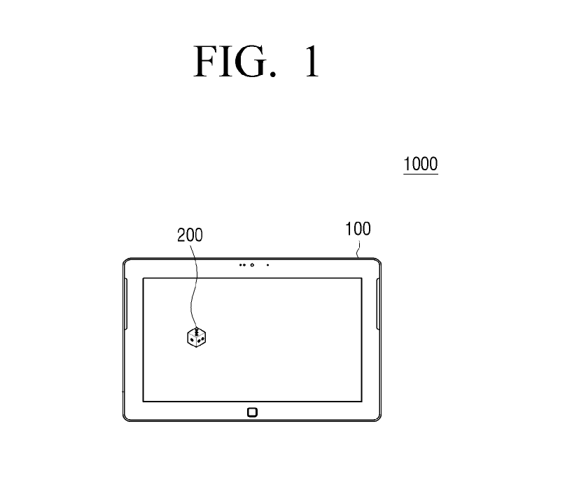

FIG. 1 illustrates an electronic system 1000 according to an embodiment of the present inventive concept.

Referring to FIG. 1, the electronic system 1000 may be constituted with an electronic apparatus 100 and an object 200 (referred to as a pattern object in the following explanation) in which electronic patterns may be arranged.

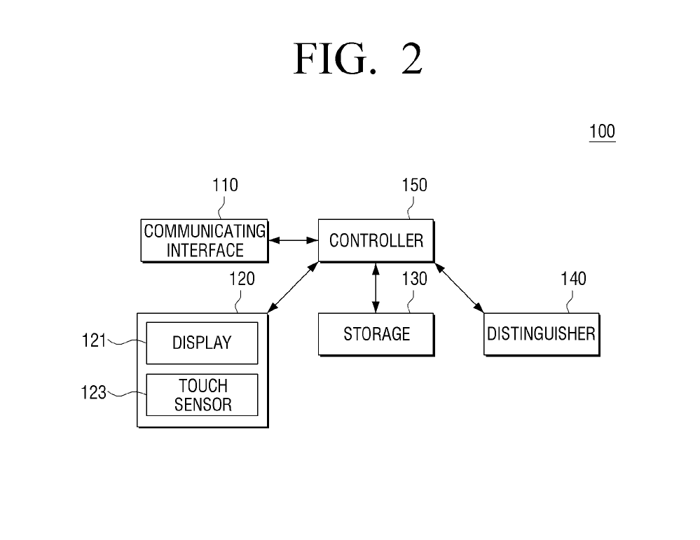

The electronic apparatus 100 may include a touch screen, and may sense a touch area associated with a touch by a user or a touch by an object in which touch patterns may be arranged. Further, when a plurality of touch areas are sensed, the electronic apparatus 100 may distinguish touch patterns based on a number of the sensed plurality of touch areas and a total distance between the plurality of touch areas, and may perform an event that corresponds to the distinguished touch patterns. A detailed explanation of an operation and a constitution of the electronic apparatus 100 is described with reference to FIG. 2.

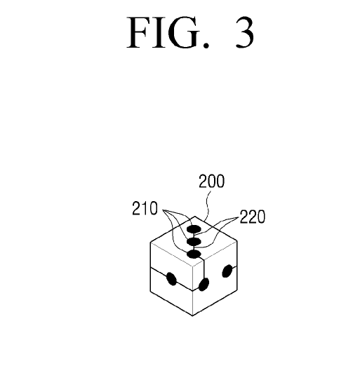

The pattern object 200 may be an object in which touch patterns that include a plurality of capacitive touch points may be arranged. The object 200 may be a cube such as, for example, a die from a pair of dice. However, the object 200 may be another shape such as, for example, a regular octahedron, a circular cone, or a quadrangular pyramid. A specific shape and an operation of the pattern object 200 is described with reference to FIGS. 3 to 5.

The above described electronic system 1000, according to an embodiment of the present inventive concept, may distinguish touch patterns based on the number of the plurality of touch areas and the total distance between the plurality of touch areas, and thus, may recognize more complicated and detailed touch patterns.

FIG. 2 is a block diagram of an example of the electronic apparatus 100 illustrated in FIG. 1.

Referring to FIG. 2, the electronic apparatus 100 may include a communicating interface 110, a user interface 120, a storage 130, a distinguisher 140, and a controller 150. The electronic apparatus 100 may be, for example, a desktop personal computer (PC), a notebook PC, a tablet PC, a Moving Pictures Expert Group Audio Layer III (MP3) device, a smartphone, or a portable media player (PMP), which includes the touch screen.

The communicating interface 110 may be formed to connect the electronic apparatus 100 with an external device (not illustrated), and may be connected by wireless communication methods (e.g., Global System for Mobil Communications (GSM), Universal Mobile Telecommunications System (UMTS), Long Term Evolution (LTE), Wireless Broadband (WiBRO), Wireless Fidelity (WiFI), and Bluetooth) as well as connected with an external device through a local area network (LAN) and an Internet network.

The user interface 120 may include a plurality of function keys with which a user may establish or select a plurality of functions supported by the electronic apparatus 100, and may output a plurality of information provided from the electronic apparatus 100 in displayed images or audio sounds. Specifically, the user interface 120 may be implemented by combining a touch sensor 123, such as, for example, a touch panel, and a display 121. This embodiment of the present inventive concept is distinguished by a device that receives a touch input that is separated from a device that displays images. Alternatively, a touch screen configured to input and output simultaneously may be used.

The display 121 may display images. Specifically, the display 121 may display images that correspond to a user manipulation and to results of an interaction with the pattern object 200, which is described below.

The touch sensor 123 may sense touch areas of a surface on the display 121. Specifically, the touch sensor 123 may sense touch areas from a touch of a user or by touch patterns of an object (e.g., a stylus) according to a capacitive method. Such a capacitive method may use an active electrical capacitive amount or a passive electrical amount. Although this embodiment of the present inventive concept is distinguished by touch areas that are sensed according to the capacitive method, alternatively, touch areas may be sensed using an IR optical layer. Thus, the touch sensor 123 may be implemented such that touch areas are sensed through a method that photographs the touch surface with IR and analyzes the photographed images.

The storage 130 may store programs that drive the electronic apparatus 100. Specifically, the storage 130 may store classes of plural commands needed to drive the electronic apparatus 100, which are programs. Herein, the programs may include operating programs to drive application programs as well as application programs to provide specific services.

The storage 130 may store information about touch patterns. Specifically, the storage 130 may store information about shapes of touch patterns and event information that correspond to each touch pattern. Herein, information about shapes of touch patterns may be images of touch patterns themselves, or information about the number of touch areas that constitute a touch pattern, and the total distance between the touch areas. The event that corresponds to each touch pattern may be a combination of, for example, inputs to a keyboard for application programs (e.g., Ctrl+Alt+2), a rotation or a translational movement of an object displayed on the screen, a brightness of the screen, an increase or decrease of the audio volume, and selection tools of the application programs (e.g., a selection of a brush in a painting application program or a selection of a type of weapon in a single shooting game).

The storage 130 may be implemented to be a storage medium within the electronic apparatus 100 and an external storage medium, e.g., a removable disk that includes a Universal Serial Bus (USB) memory or a web server through a network.

The distinguisher 140 may distinguish touch patterns about the sensed touch areas based on the number of the sensed touch areas and the total distance between the sensed touch areas. Specifically, based on the number of the sensed touch areas, the distinguisher 140 may determine which touch pattern correspond. For example, touch patterns may include a plurality of touch points. Thus, when only one touch area is sensed, the distinguisher 140 may determine that it is a normal touch.

In contrast, when a plurality of touch areas are sensed, the distinguisher 140 may determine whether intervals between the plurality of the sensed touch areas are within a predetermined distance range. Specifically, while touch patterns caused by the pattern object 200 may be arranged within a predetermined range, multiple touch points touched by a user may be within a wider range on the screen. Therefore, the distinguisher 140 may determine whether intervals between the plurality of touch areas are within a predetermined distance range in order to include the pattern object 200 and touch areas associated with touch patterns made by multiple touch points touched by a user.

The distinguisher 140 may distinguish touch patterns based on the total distance between a plurality of touch areas. Specifically, the distinguisher 140 may distinguish touch patterns by calculating distances between a plurality of touch areas, adding the calculated distances, and comparing the sum with the total distances of the prestored touch patterns. Under this process, the distinguisher 140 may distinguish touch patterns by using the averaged total distance between the touch areas for a predetermined period of time in which the touch areas may be sensed for the predetermined period of time.

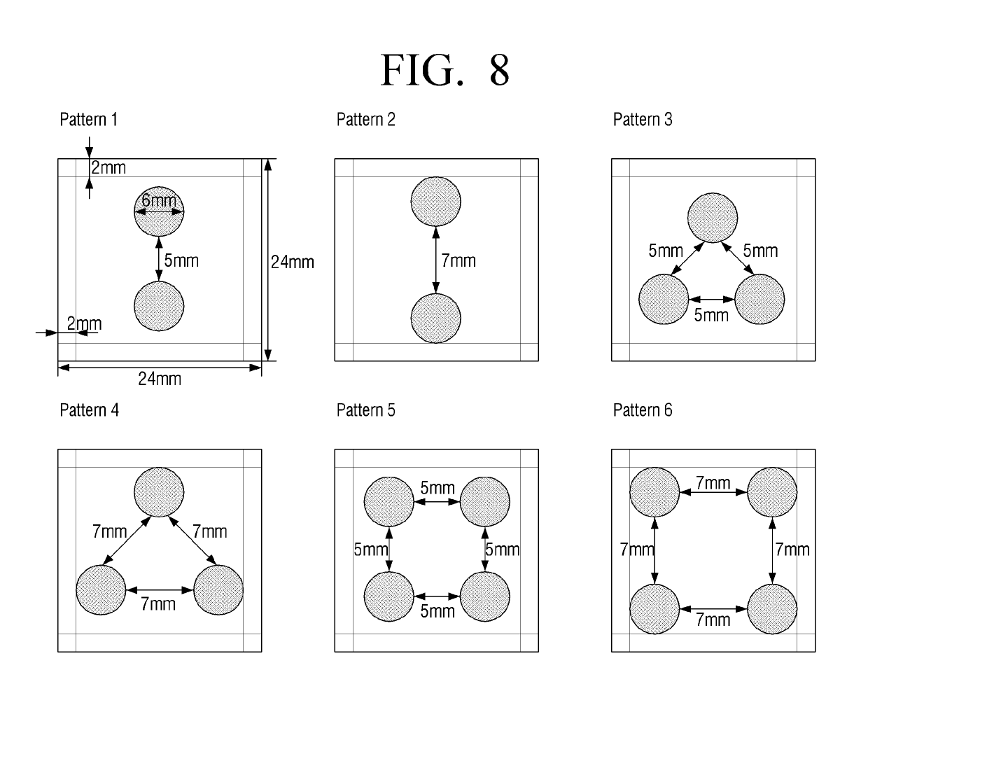

Further, the distinguisher 140 may sense a direction of the distinguished touch pattern. Specifically, the distinguisher 140 may sense a direction of the distinguished touch pattern based on a direction of an arrangement of two touch areas that have a predetermined distance among a plurality of touch areas. Further, the distinguisher 140 may distinguish a direction of the distinguished touch pattern based on a format of an arrangement of the distinguished touch areas. Relevant touch patterns are described with reference to FIGS. 8 to 11.

Further, the distinguisher 140 may distinguish positions of the distinguished touch patterns on the display apparatus. Specifically, the distinguisher 140 may distinguish positions on the display apparatus with respect to the touch patterns that form specific touch patterns among a plurality of touch areas.

The controller 150 may control each unit within the electronic apparatus 100. Specifically, the controller 150 may control the user interface 120 to execute application programs based on a user command to drive application programs, and to display images that correspond to the application programs. Such a command to drive an application program may be communicated by a motion recognized as a touch pattern.

In response to a touchinput sensed from a hand of a user or the pattern object 200 while images are displayed, the controller 150 may control the distinguisher 140 to determine whether the touch input corresponds to a touch pattern. Further, in response to a correspondence between the touch input and a touch pattern, the controller 150 may control the distinguisher 140 to distinguish which touch pattern is formed, and may perform an event that corresponds to the distinguished touch pattern. For example, when an event that corresponds to a specific touch pattern associated with a combination of key inputs, the controller 150 may perform an operation that corresponds to the combination of key inputs. When an event that corresponds to a specific touch pattern touch associated with a rotation or a translational movement of an object displayed on the screen, a brightness of the screen, or an increase or decrease of the audio volume, the controller 150 may perform an operation that corresponds to this specific touch pattern.

Further, the controller 150 may perform an event that corresponds to both the distinguished touch pattern and a direction of the touch pattern. For example, when the distinguished touch pattern touch is a touch pattern related to an adjustment of the volume, the controller 150 may adjust the volume according to the direction of the distinguished touch pattern. Thus, when a touch pattern is related to an adjustment of the volume and the direction of the touch pattern is toward, for example, 0°, the controller 150 may reduce the volume to a muted state. Further, when the touch pattern is toward, for example, 90°, the controller 150 may adjust the volume to 50% of the maximum volume.

Further, the controller 150 may perform an event according to the distinguished touch pattern and a position of the distinguished a touch pattern on the display apparatus. For example, when the distinguished touch pattern is a touch pattern related to an adjustment of the volume, the controller 150 may adjust the volume according to the position of the distinguished touch pattern on the display apparatus. Thus, when a touch pattern is a touch pattern related to an adjustment of the volume and the touch pattern occurs on a lower portion of the display apparatus, the controller 150 may reduce the volume to a muted state. Further, when the touch pattern occurs on an upper portion of the display apparatus, the controller 150 may increase the volume by a predetermined amount with respect to a current volume.

Although this embodiment of the present inventive concept is explained with respect to a method of processing an event related to an adjustment of the volume, a plurality of events that may be performed by the electronic apparatus 100 may be mapped with touch patterns, and a direction and a position on the display apparatus with respect to each touch pattern may also be simultaneously applied in implementations of the present inventive concept.

As described above, the electronic apparatus 100 according to an embodiment of the present inventive concept may distinguish complicated and detailed touch patterns because touch patterns may be distinguished based on the number of the plurality of touch areas and the total distance between the plurality of touch areas.

FIG. 3 illustrates an example of the pattern object 200 in which the touch patterns, described with reference to FIG. 2, are arranged on sides of the pattern object 200.

Referring to FIG. 3, a touch pattern may be arranged on a side of the pattern object 200. Herein, the pattern object 200 may be cubic form such as, for example, a die from a pair of dice. However, the pattern object 200 may not be limited to such a form. The pattern object 200 may have another shape such, for example, as regular octahedron, a hexagonal pyramid, or any general polyhedron.

Each touch pattern may include a plurality of capacitive touch points 210 and the capacitive touch points 210 may be connected with each other through capacitive lines 220.

Such capacitive touch points 210 and capacitive lines 220 may be made of metal materials. Therefore, when a user grips the side of the pattern object 200 on which the touch pattern is arranged or another side, a capacitive amount caused by a touch of the user may be delivered to the capacitive touch points 210 through the capacitive lines 220, such that the touch pattern displayed on the touch screen may recognize the capacitive touch.

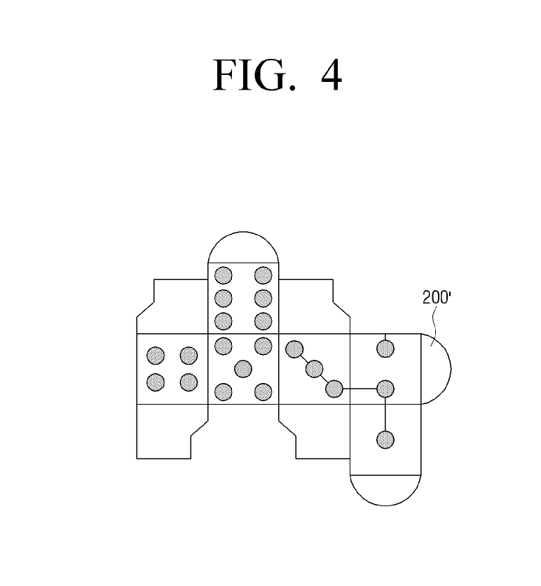

FIG. 4 illustrates an example in which the pattern object 200 illustrated in FIG. 3 is presented in one dimension.

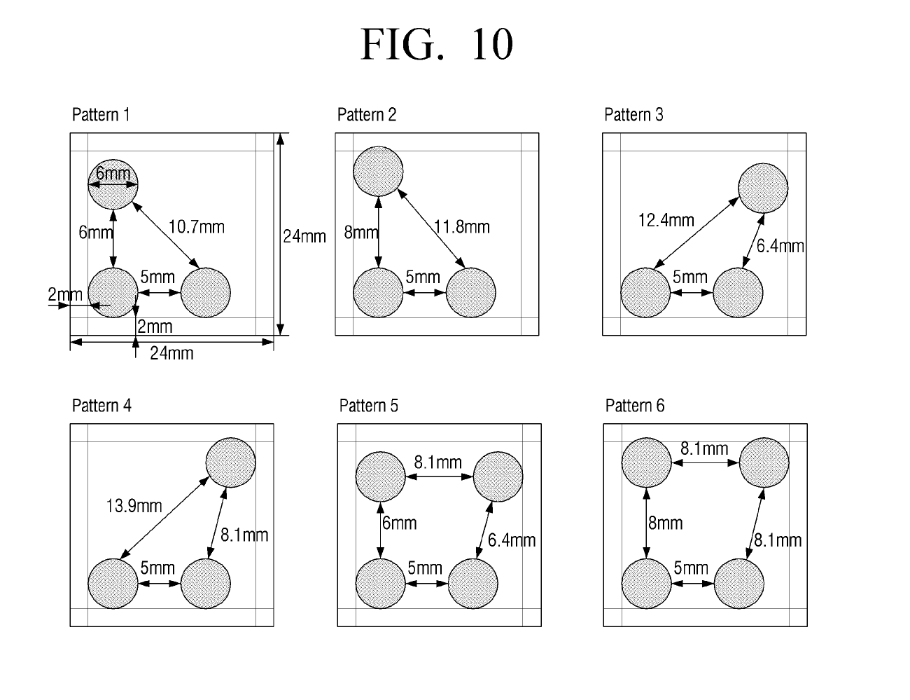

Referring to FIG. 4, each side of the pattern object 200′ may have a touch pattern that is different from the touch patterns of the other sides. The explanation associated with the embodiment of the present inventive concept illustrated in FIG. 4 describes that the different sides have different numbers of touch points like, for example, a die from a pair of dice. However, when being implemented, touch patterns such as those illustrated in FIG. 8 or FIG. 10 may be arranged on the sides of the pattern object 200.

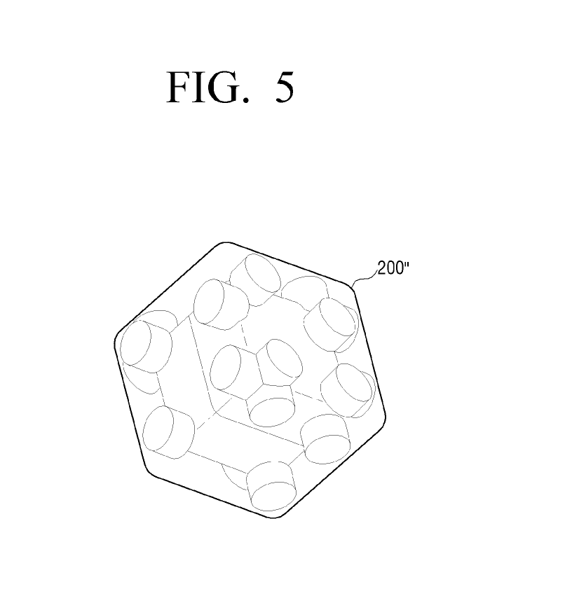

Although in the explanations associated with the embodiment of the present inventive concept illustrated in FIGS. 3 and 4 the pattern object 200 is described to operate only when a touch of a user causes a capacitive amount. However, when being implemented, the pattern object 200 may have a form that may generate a capacitive amount internally. As illustrated in FIG. 5. In this case, when fingers of a user do not directly touch the pattern object 200, e.g., when a user wears a glove, the pattern object 200 may still interact with the electronic apparatus 100.

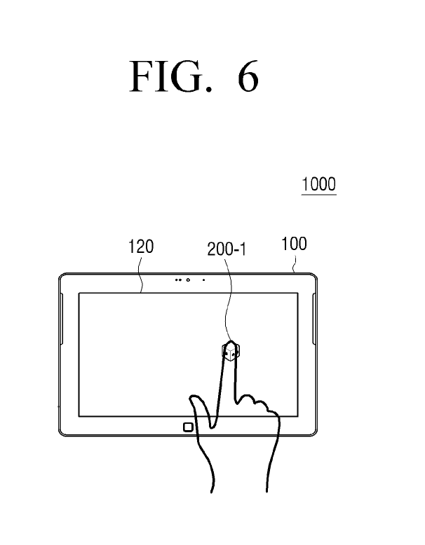

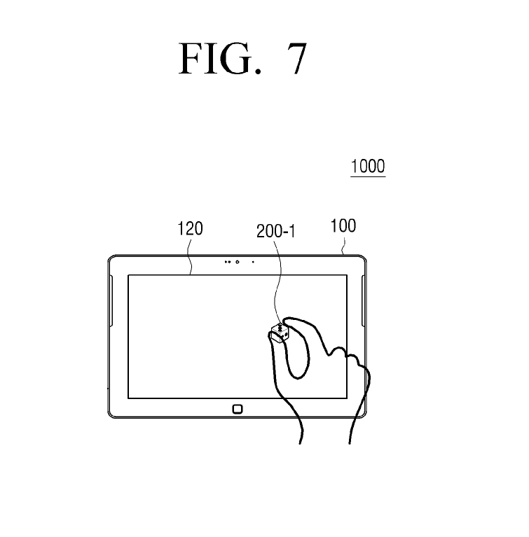

FIGS. 6 and 7 are views to explain operation of the electronic system 1000 according to an embodiment of the present inventive concept. Specifically, FIGS. 6 and 7 illustrate a representative game application program in which a user may interact with the game through the pattern object 200-1. In FIG. 6, a user may touch an upper side of the pattern object 200-1. In FIG. 7, a user may touch a sectioned side of the pattern object 200-1.

Accordingly, a capacitive amount of a user may be delivered to the lower side of the pattern object 200-1 by touching the upper side or the sectioned side of the pattern object 200-1, and the pattern object 200-1 may interact with the electronic apparatus 100.

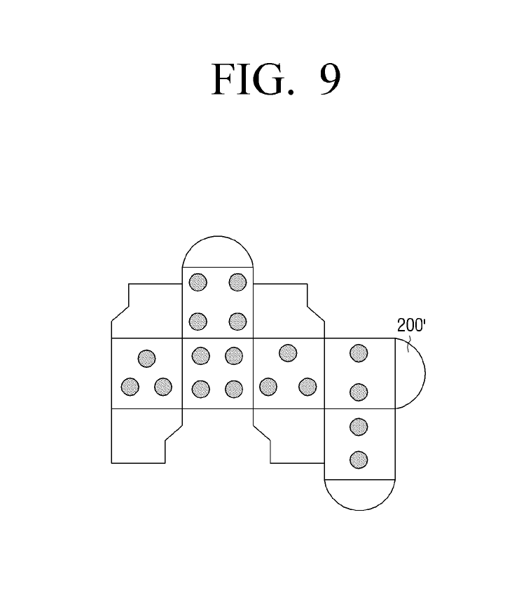

FIG. 8 illustrates an example of touch patterns according to an embodiment of the present inventive concept, and FIG. 9 illustrates an example of the pattern object 200′ that use the touch patterns illustrated in FIG. 8.

Referring to FIGS. 8 and 9, each touch pattern may include a plurality of touch points, and the plurality of touch points within one touch pattern may be arranged with each other to be symmetrical. The touch patterns of FIGS. 8 and 9 may be different from each other in terms of the total distance between the touch points. Therefore, the electronic apparatus 100 may recognize a touch pattern based on the total distance between the touch points within the touch pattern.

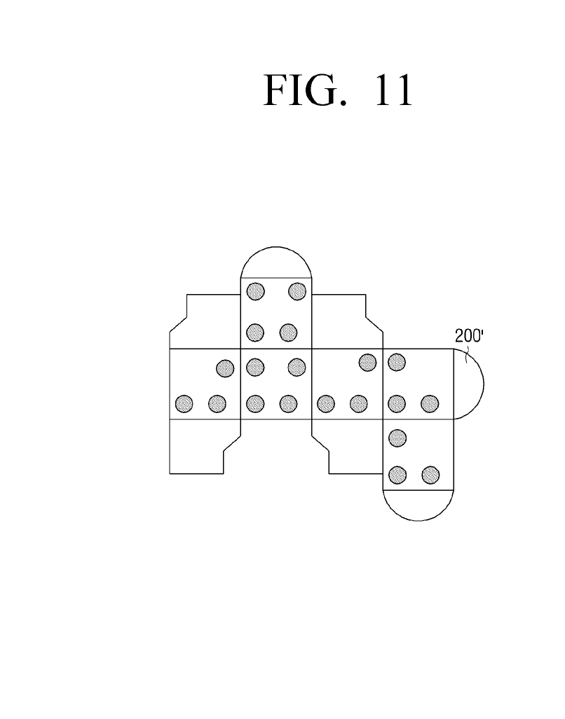

FIG. 10 illustrates an example of touch patterns according to an embodiment of the present inventive concept, and FIG. 11 illustrates an example of the pattern object 200′ that uses the touch patterns illustrated in FIG. 10.

Referring to FIGS. 10 and 11, each touch pattern may include a plurality of touch points, and more than three touch points within one touch pattern may be arranged to be asymmetrical. Further, within a touch pattern, the distances between the touch points may be different from each other. Therefore, the electronic apparatus 100 may recognize a touch pattern based on the total distance of the touch points within the touch pattern.

Further, referring to FIGS. 10 and 11, two touch points, among the plurality of touch points, may have a predetermined fixed distance (e.g.,5 mm). Therefore, the electronic apparatus 100 may distinguish the touch pattern by using the total distance between the touch points and may confirm a direction of an arrangement of the touch pattern by using positions of the two points that have the predetermined fixed distance and the other touch points. For example, while front/back or left/right may not be distinguished with respect to a touch pattern that has two touch points, a direction of an arrangement of the pattern object 200′ may be distinguished when more than three touch points are arranged to be asymmetrical.

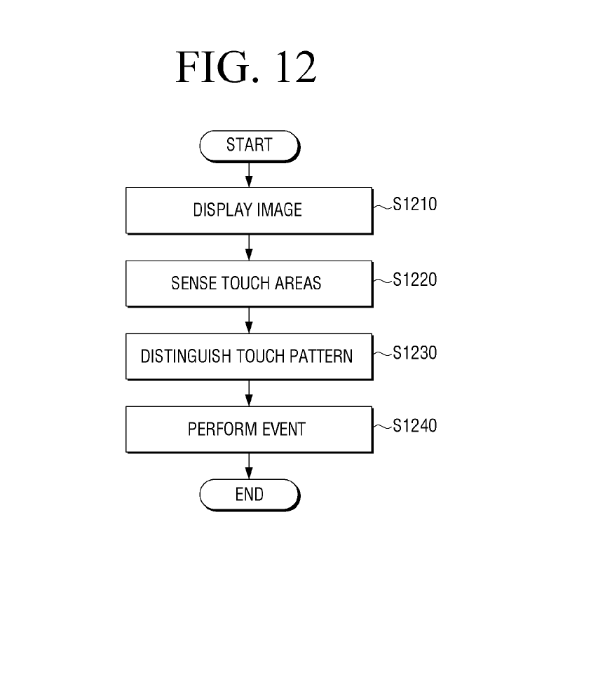

FIG. 12 is a flowchart illustrating a method of controlling operation of the electronic apparatus 100 according to an embodiment of the present inventive concept.

Referring to FIG. 12, an image may be displayed first at S1210. Specifically, an image or video provided from an application program selected by a user may be displayed. While the image is displayed, audio sounds may simultaneously be output.

At S1220, a touch area on the display surface may be sensed. Specifically, a touch area may be sensed according to the capacitive method by a touch of a user or a touch pattern of an object. Although this embodiment of the present inventive concept is distinguished by a touch area that is sensed according to the capacitive method, alternatively, a touch area may be sensed by using an IR optical layer. An operation to distinguish a touch pattern when a user generates a plurality of touch areas is described below. When a user generates one touch area, an event that corresponds to the touch area may be performed without a separate performance of an operation to distinguish a touch pattern.

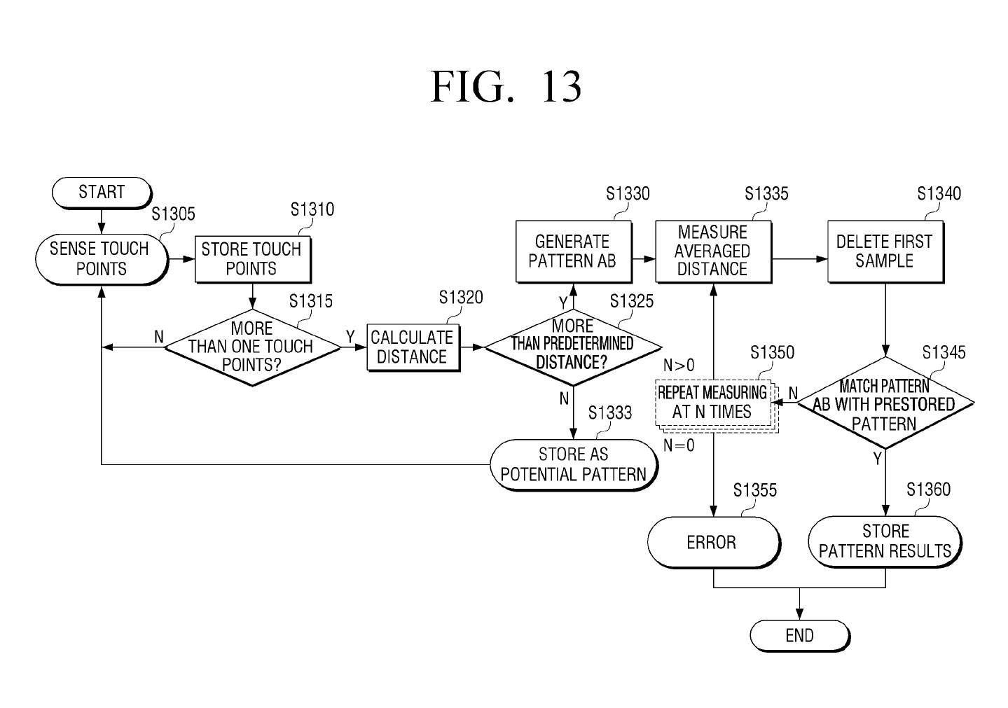

At S1230, a touch pattern with respect to the sensed touch areas may be distinguished based on the number of the sensed capacitive touch areas and the total distance between the sensed capacitive touch areas. Specifically, a touch may be determined to correspond to a touch pattern based on the number of the sensed touch areas. If a plurality of touch patterns are determined to be within a predetermined range, the touch may be determined to correspond to a touch pattern, and the touch pattern may be distinguished by comparing prestored touch pattern information based on the total distance between the plurality of touch areas. Specific operations to recognize a touch pattern is described below with reference to FIGS. 13 to 15.

At S1240, an event that corresponds to the distinguished touch pattern may be performed. For example, when an event that corresponds to a specific touch pattern associated with a combination of key inputs, the operation that corresponds to the combination of key inputs may be performed. When an event that corresponds to a specific touch pattern associated with a rotation or a translational movement of an object displayed on the screen, a brightness of the screen, or an increase or decrease of the audio volume, the operation that corresponds to this specific touch pattern may be performed.

Thus, a method of controlling operation of the electronic apparatus 100 according to an embodiment of the present inventive concept may distinguish the touch pattern based on the number of the plurality of touch areas and the total distance between the plurality of touch areas, and may distinguish more complicated and detailed touch patterns. The method of controlling operation of the electronic apparatus 100 illustrated in FIG. 12 may be implemented in the electronic apparatus 100 that has a form as described with reference to FIG. 2, and in electronic apparatuses that have other forms.

Further, the method of controlling operation of the electronic apparatus 100 described above may be implemented in programs (or applications) that include algorithms that may run on a computer, and the programs may be stored and may be provided in a non-transitory computer readable recording medium.

A non-transitory computer readable recording medium may indicate a medium which may store data semi-permanently and may be read by devices, rather than a medium that stores data temporarily such as, for example, a register, a cache, or a short-term memory. Specifically, the various applications or programs described above may be stored and provided in a non-transitory computer readable recording medium such as, for example, a compact disc (CD), a digital video disk (DVD), a hard disk, a Blu-ray disk, a Universal Serial Bus (USB) device, a memory card, or a read-only memory (ROM).

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), compact disc ROM (CD-ROMs), magnetic tapes, floppy disks, and optical data storage devices. The computer-readable recording medium can also be distributed over network coupled computer systems so that the computer-readable code is stored and executed in a distributed fashion. The computer-readable transmission medium can be transmitted through carrier waves or signals (e.g., wired or wireless data transmission through the Internet). Also, functional programs, codes, and code segments to accomplish the present general inventive concept can be easily construed by programmers skilled in the art to which the present general inventive concept pertains.

FIGS. 13 to 15 are flowcharts illustrating operations to recognize touch patterns as initially described with reference to FIG. 12.

Referring to FIG. 13, when a touch (touch point A) is sensed on the touch screen at S1305, the touch may be recognized as a capacitive contact that corresponds to a pattern object, and may be stored in a memory for next processing at S1310. When being implemented, such an operation may convert each new touch point into a capacitive contact within the memory by using a command such as, for example, “HandlePointEntered,” and may generate a new pattern based on this contact.

Further, when another touch (touch point B) is sensed, it may be determined at S1315-Y to be a plurality of touch points, an interval between the two touch points may be calculated at S1320, and the calculated interval may be compared to determine whether it is less than a predetermined interval (e.g., interval critical point) at S1325.

When at S1325-Y the calculated interval is more than a predetermined interval, touch point A and touch point B may be stored within the memory such that a touch point pattern is formed at S1330.

However, when at S1325-N the calculated interval is less than a predetermined interval, or when a plurality of touch points are not generated, the corresponding point (or corresponding points) may be stored at S1333 in the memory as a new capacitive contact to be used as data to determine whether an interval of next new touch points is more than the interval critical point.

Whenever touch points within the memory are sensed to be two or more, or when a touch point pattern is sensed, the total interval between the touch points within the touch point pattern per frame may be calculated at S1335. When being implemented, the total distance of the touch points within each touch pattern may be calculated in real-time by using a command such as, for example, “updateDistance.”

So that samples of the values may be extracted, in other words, so that a user may conveniently put his fingers on the object, at S1340 several initial samples may be ignored.

At S1345, the touch patterns may be filtered according to the number of the sensed touch points, and may be classified based on the calculated total intervals. When being implemented, the touch patterns may be distinguished by using a command such as, for example, “classifyface.” When at S1345-Y there is a match between a touch pattern and a prestored touch pattern, touch pattern results may be stored at S1360.

When at S1345-N the number of the touch points is not uniform to any one of the prestored touch patterns, this may be recognized as an error, and at S1350 a third process to generate a new sampling set may be repeated. The maximum number of attempts to try to correct such errors may be predetermined to be a number in which too many errors may be recognized to sense a touch point pattern.

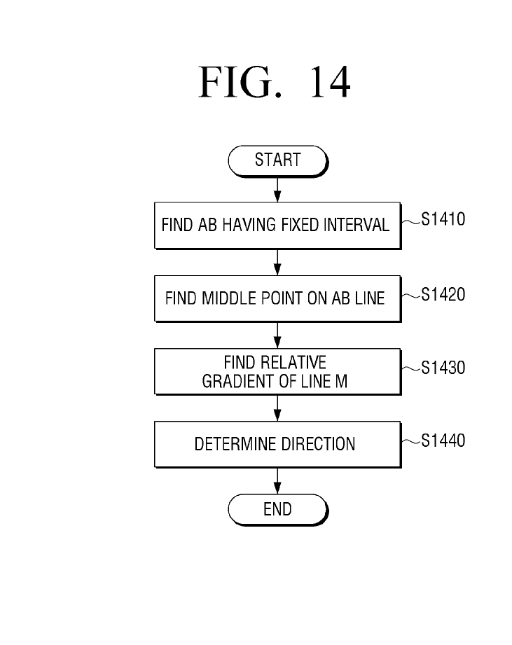

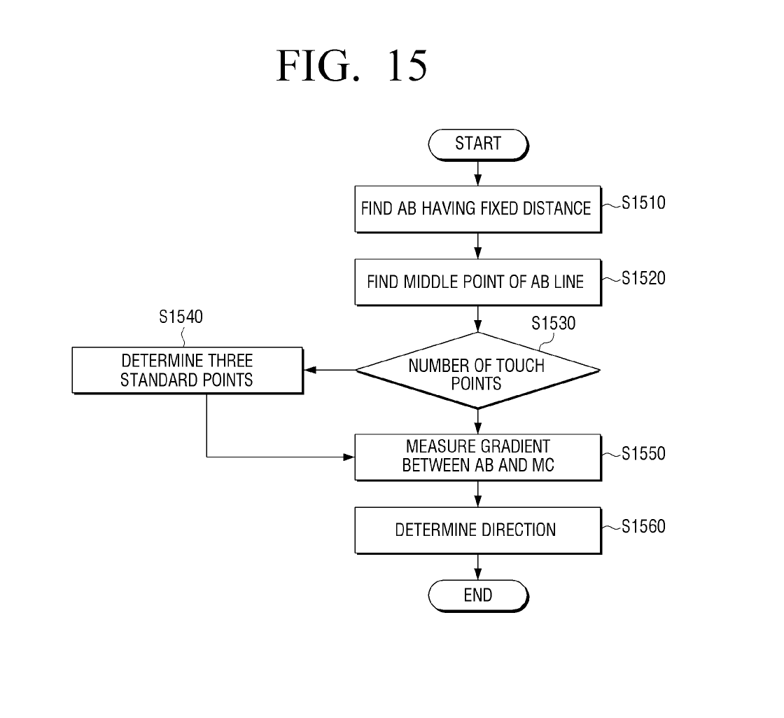

The explanation above describes a method to distinguish the touch patterns. However, operations may be performed to determine directions of arrangements of the distinguished touch patterns as well as to distinguish the touch patterns. The relevant operations are described with reference to FIGS. 14 and 15.

An embodiment of the present inventive concept illustrated in FIG. 14 may be used in a case in which the touch patterns illustrated in FIG. 10 are used. Referring to FIG. 14, two touch points, among more than three touch points, may be used to recognize an axis of an object. Thus, two touch points that have a predetermined interval may be extracted from among the sensed touch points. The relation between the two touch points may be referred to as a fixed interval.

Relations between the other touch points within the touch pattern should be different from the fixed interval.

At S1410, it may be determined if there is a fixed interval between touch point A and touch point B. A first line that connects point A and point B may be determined, and at S1420 a middle point M of the first line may be calculated.

Further, a second line that connects the middle point M with a third touch point C within the touch pattern may be determined, and at S1430 a gradient of the second line may be measured in order to determine an absolute angle of the object on the display. Such a gradient may be calculated, for example, with a one-factor valuable arc tangent and a contrary two-factor valuable arc tangent in order to determine a correct quadrant of the angle and thus, at S1440, a direction of the object on the display may be determined.

When being implemented, the operation illustrated in FIG. 14 may use a command such as, for example, “ReturnReferencePoints”, which may return three touch points, and a command such as, for example, “UpdateOrientation”, which may include the two points and the three points to determine the direction.

The explanation above describes a method to determine a direction of the touch pattern that includes three sensed touch points. However, operations may be performed to determine a direction of a touch pattern that includes more than four touch points. The relevant operations are described below with reference to FIG. 15.

Referring to FIG. 15, when at S1510 it may be determined that there is a predetermined fixed interval between touch point A and touch point B, a line that connects point A and point B may be determined, and at S1520 a middle point M of the line may be calculated.

The number of touch points may be determined at S1530. When the number of touch points is three at S1540, an angle between a third touch point and the middle point M may be measured at S1550 and thus, at S1560, a direction of the object on the display may be determined according to the method illustrated in FIG. 14.

In contrast, when the number of touch points is four, a third touch point to be used to calculate the direction may be determined at S1530. Specifically, a touch point C that may be farthest from the middle point M may be used as the third touch point. Although the explanation above uses the farthest touch point from the middle point M as the third touch point, the nearest touch point from the middle point M may be also used.

The foregoing embodiments and advantages of the present general inventive concept are merely explanatory and are not to be construed as limiting the embodiments of the present inventive concept. The present teaching may be readily applied to other types of apparatuses. Also, the description of the embodiments of the present inventive concept is intended to be illustrative, and not to limit the scope of the claims.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An electronic apparatus, comprising:
a display configured to display an image;
a touch sensor configured to sense more than three touch areas on a surface of the display;
a distinguisher configured to distinguish a touch pattern with respect to the sensed touch areas based on a number of the sensed touch areas and a total distance between the sensed touch areas; and
a controller configured to perform an event that corresponds to the distinguished touch pattern.

2. The electronic apparatus of claim 1, wherein the distinguisher is configured to determine whether distances between the sensed touch areas are within a predetermined interval range, and to distinguish the touch pattern by comparing the total distance between the sensed touch areas with prestored information.

3. The electronic apparatus of claim 1, wherein the distinguisher is configured to distinguish the touch pattern by using an average of the total distance between the sensed touch areas for a predetermined time with respect to the touch areas sensed during the predetermined time.

4. The electronic apparatus of claim 1, wherein the controller is configured to perform the event that corresponds to the distinguished touch pattern and a position of the distinguished touch pattern on the display.

5. The electronic apparatus of claim 1, wherein the controller is configured to control the display to display an image that corresponds to the distinguished touch pattern.

6. The electronic apparatus of claim 1, wherein a touch area of the more than three touch areas is configured to be generated at a location of an object in which the touch pattern, in a form of a plurality of capacitive touch points, is arranged on a first side of the object.

7. The electronic apparatus of claim 6, wherein the object includes capacitive lines arranged on the first side and on a second side different from the first side in order to deliver a capacitive amount caused by a touch of a user to the plurality of capacitive touch points.

8. The electronic apparatus of claim 6, wherein a first of the plurality of capacitive touch points has a predetermined distance from a second of the plurality of capacitive touch points.

9. The electronic apparatus of claim 8, wherein the distinguisher is configured to sense a direction of the touch pattern by using directions and distances between the first of the plurality of capacitive touch points that has the predetermined distance from the second of the plurality of capacitive touch points and other of the plurality of capacitive touch points.

10. The electronic apparatus of claim 9, wherein the controller is configured to perform the event that corresponds to the distinguished touch pattern and the sensed direction of the touch pattern.

11. A method of controlling an electronic apparatus, comprising:
displaying an image;
sensing more than three touch areas on a surface of a display;
distinguishing a touch pattern with respect to the sensed touch areas based on a number of the sensed touch areas and a total distance between the sensed touch areas; and
performing an event that corresponds to the distinguished touch pattern.

12. The method of claim 11, wherein the distinguishing comprises determining whether distances between the sensed touch areas are within a predetermined interval range, and distinguishing the touch pattern by comparing the number of the sensed touch areas, the total distance between the sensed touch areas, and prestored information.

13. The method of claim 11, wherein the distinguishing comprises distinguishing the touch pattern by using an average of the total distance between the sensed touch areas for a predetermined time with respect to the touch areas sensed during the predetermined time.

14. The method of claim 11, wherein the performing comprises performing the event that corresponds to the distinguished touch pattern and a position of the distinguished touch pattern on the display.

15. The method of claim 11, wherein the performing further comprises displaying an image that corresponds to the distinguished touch pattern.

16. The method of claim 11, wherein a touch area of the more than three touch areas is generated at a location of an object in which the touch pattern, in a form of a plurality of capacitive touch points, is arranged on a side of the object.

17. The method of claim 16, wherein a first of the plurality of capacitive touch points has a predetermined distance from a second of the plurality of capacitive touch points.

18. The method of claim 17, wherein the distinguishing further comprises sensing a direction of the touch pattern by using directions and distances between the first of the plurality of capacitive touch points that has the predetermined distance from the second of the plurality of capacitive touch points and other of the plurality of capacitive touch points.

19. The method of claim 18, wherein the performing comprises performing the event that corresponds to the distinguished touch pattern and the sensed direction of the touch pattern.

20. A non-transitory computer-readable recording medium comprising a program to implement a method of controlling an electronic apparatus, wherein the method comprises:
displaying an image;
sensing more than three touch areas on a surface of a display;
distinguishing a touch pattern with respect to the sensed touch areas based on a number of the sensed touch areas and a total distance between the sensed touch areas; and
performing an event that corresponds to the distinguished touch pattern.
